(19) United States
(12) Patent Application Publication
(10) Pub. No.: US 2023/0370929 A1
(43) Pub. Date: Nov. 16, 2023

(54) DETERMINING IN-COVERAGE OR UNREACHABILITY INFORMATION IN SATELLITE AREA NETWORK

(71) Applicant: SAMSUNG ELECTRONICS CO., LTD., Suwon-si (KR)

(72) Inventors: Lalith KUMAR, Bangalore (IN); Avneesh TIWARI, Bangalore (IN); Aman AGARWAL, Bangalore (IN); Kailash Kumar JHA, Bangalore (IN)

(21) Appl. No.: 18/318,172

(22) Filed: May 16, 2023

(30) Foreign Application Priority Data
May 16, 2022 (IN) 202241028059
Apr. 17, 2023 (IN) 202241028059

(51) Int. Cl. H04W 36/14; H04W 52/02

(52) U.S. Cl. CPC H04W 36/14; H04W 52/0248; H04W 84/042

(57) ABSTRACT

The disclosure relates to a 5G or 6G communication system for supporting a higher data transmission rate. Embodiments herein provide a method for determining in-coverage or unreachability information in a satellite area network by a UE. The method includes determining whether the UE remains in no service on at least one of a PLMN and RAT till the coverage returns or the UE selects other PLMN or RAT to continue to receive the service. The method includes sending a unreachability period to an AMF.

### CROSS-REFERENCE TO RELATED APPLICATIONS

This application is based on and claims priority under 35 U.S.C. § 119 to Indian Patent Application No. 202241028059 filed on May 16, 2022, and Indian Patent Application No. 202241028059 filed on Apr. 17, 2023, in the Indian Intellectual Property Office, the disclosure of which is incorporated by reference herein in its entirety.

### BACKGROUND

### 1. Field

Due to a discontinuous coverage (DC), a user equipment (UE) may have access to satellite service coverage only at specific time and places. In the discontinuous coverage of a satellite scenario, the UE is bound to have coverage at only specific times due to a continuous movement of the satellites or satellite constellations. The satellite means an artificial body placed in orbit round the earth or moon or another planet in order to collect information or for communication. The satellite constellation means group of satellites, placed in orbit round the earth or moon or another planet in order to collect information or for communication.

### 2. Description of Related Art

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Accordingly, the embodiment herein is to provide a method for determining in-coverage or unreachability information in a satellite area network. The method includes determining, by a UE, that the UE enters a discontinuous coverage on at least one of a PLMN and a RAT in a geographic area. Further, the method includes determining, by the UE, an unreachability period of the UE based on coverage information of at least one of the PLMN and RAT in the geographic area. Further, the method includes determining, by the UE, whether the UE remains in no service on the at least one of the same PLMN and RAT till the coverage returns or the UE selects other PLMN or the RAT to continue to receive the service. In an embodiment, the method includes sending the unreachability period to an AMF apparatus in the satellite area network and performing power saving during the discontinuous coverage when the UE determines to remains in no service on the same PLMN and the RAT till the coverage returns. In another embodiment, the method includes selecting other PLMN or RAT in the geographic area and continuing receiving the service on the other selected PLMN or the RAT in the geographic area when the UE determines to selects the other PLMN or the RAT.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The method, the UE and the AMF apparatus are illustrated in the accompanying drawings, throughout which like reference letters indicate corresponding parts in the various figures. The embodiments herein will be better understood from the following description with reference to the drawings, in which:

FIG. 1 illustrates an example scenario of a system for determining in-coverage or unreachability information in a satellite area network according to embodiments as disclosed herein;

FIG. 2 illustrates an example scenario for determination a leaving coverage indication according to embodiments as disclosed herein;

FIG. 3 illustrates a method for determining the leaving coverage indication due to discontinuous coverage or any other unavoidable event according to embodiments as disclosed herein;

FIG. 4 illustrates an example scenario of determination of expected in-coverage time by a network during the discontinuous coverage or under avoidable situations according to embodiments as disclosed herein;

FIG. 5 illustrates a sequence diagram of a determination of expected in-coverage time by the network during the discontinuous coverage or the under avoidable situations according to embodiments as disclosed herein;

FIG. 6 illustrates an example scenario of determination of leaving coverage indication due to the discontinuous coverage or any other unavoidable event according to embodiments as disclosed herein;

FIG. 7 illustrates a sequence diagram illustrating determination of leaving coverage indication due to the discontinuous coverage or any other unavoidable event according to embodiments as disclosed herein;

FIG. 8 illustrating a scenario of determination of expected in-coverage time by the network during discontinuous coverage or under avoidable situations according to embodiments as disclosed herein;

FIG. 9 illustrates a scenario of determination of expected in-coverage time by the network during discontinuous coverage or under avoidable situations according to embodiments as disclosed herein;

FIG. 10 illustrates hardware components of the UE according to embodiments as disclosed herein;

FIG. 11 illustrates hardware components of an AMF apparatus according to embodiments as disclosed herein;

FIG. 12 illustrates a flowchart of a method, implemented by the UE, for determining the in-coverage or the unreachability information in the satellite area network, according to embodiments as disclosed herein; and

FIG. 13 illustrates a flowchart of a method, implemented by the AMF apparatus, for determining the in-coverage or the unreachability information in the satellite area network, according to embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

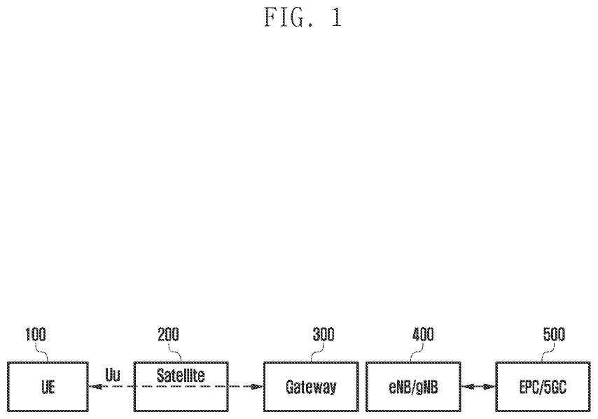

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The principal the embodiment herein is to provide a method and a system for determining in-coverage or unreachability information in a satellite area network.

Another embodiment herein is to determine whether a UE remains in no service on at least one of a same PLMN and RAT till a coverage returns or the UE selects other PLMN or the RAT to continue to receive the service.

Yet another embodiment herein is to send an unreachability period to an AMF apparatus in the satellite area network and perform a power saving during the discontinuous coverage when the UE determines to remains in no service on the same PLMN and the RAT till the coverage returns.

Yet another embodiment herein is to select other PLMN or RAT in the geographic area and continuing receive the service on the other selected PLMN or the RAT in the geographic area when the UE determines to selects the other PLMN or the RAT.

Yet another embodiment herein is to provide an indication of correct leaving notification and expected in-coverage time during a discontinuous coverage (DC) in the satellite area network.

FIG. 1 illustrates an example scenario of a system for determining in-coverage or unreachability information in a satellite area network according to embodiments as disclosed herein. The FIG. 1 describes the typical deployment for the satellite communication, a satellite (200) is connected to a gateway (300) which is connected to the RAN node (e.g., eNB/gNB (400)) through which the 5G system.

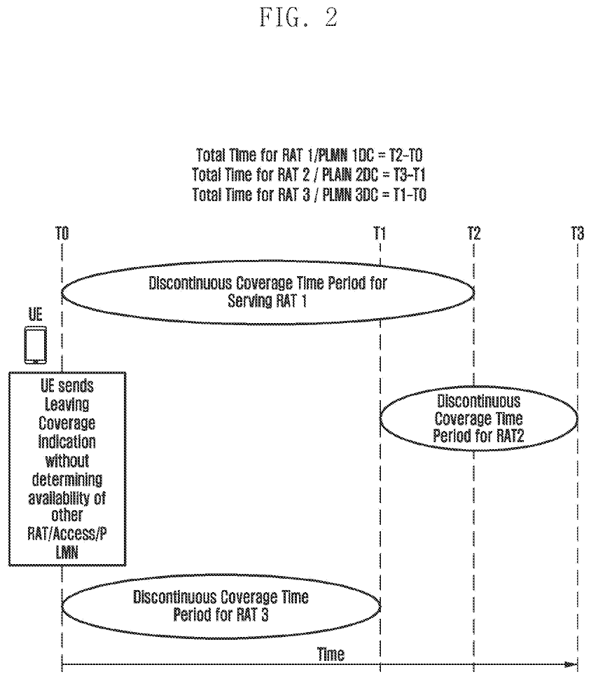

FIG. 2 illustrates an example scenario for determination a leaving coverage indication according to embodiments as disclosed herein. The UE (100) enters an IDLE mode when the UE (100) is within a network coverage and leaves the network coverage while the UE (100) is in the IDLE mode. In this case, a network (not shown) determines that the UE (100) is reachable and pages the UE (100), but in fact the UE (100) is out of the network coverage and the paging would be fail at the UE (100).

In order to avoid unnecessary paging, the UE (100) notifies the network that the UE (100) is leaving the network coverage and when the UE (100) returns to the coverage area. The UE (100) determines that the UE (100) is about to leave the network coverage based on coverage information, e.g., satellite ephemeris or the like, while the UE (100) is in either a CONNECTED mode or an IDLE mode. The UE (100) indicates a leaving coverage indication in a service request/attach procedure/registration procedure/tracking area update (TAU) procedure. The leaving coverage indication indicates that the UE (100) is about to leave the network coverage. Upon receipt of the leaving converge indication, an access and mobility function (AMF) apparatus (700a) considers that the UE (100) is unreachable. When the UE (100) enters the network coverage, the UE (100) sends a service request or a registration request to the AMF apparatus (700a) and the network that the UE (100) is back in the coverage area and reachable again.

In an example, the UE (100) is in the coverage area of a satellite radio access technology (RAT) 1/public land mobile network (PLMN) 1 and camped to it. At time TO, the UE (100) determines that the UE (100) is about to leave the network coverage based on the coverage information, like satellite ephemeris data of the satellite RAT1/PLMN 1 while the UE (100) is in the CONNECTED mode or the IDLE mode. The UE (100) indicates the leaving coverage indication to the AMF apparatus (700a)/mobility management entity (MME) in the service request/attach procedure/registration procedure/TAU procedure. The leaving coverage indication indicates that the UE (100) is about to leave the network coverage. Upon receipt of leaving converge indication, the AMF apparatus (700a) considers that the UE (100) is unreachable.

There are other satellite such as RAT(s)/PLMN(s) (i.e., RAT 2/PLMN 2 and RAT 3/PLMN 3) which is available to the UE (100) for services (at T0 and T1 time respectively). However, at time T0 or at similar times, the UE (100) finds the service from another RAT or PLMN such RAT2/PLMN2 which is available and can provide service to the UE (100). The UE (100) selects and/or camps on the RAT 2/PLMN 2 and obtains the service. In this case, the UE (100) is determining and indicating the leaving coverage notification on the basis of the coverage information of the serving RAT/PLMN only. But there is another RAT/PLMN (RAT 2/PLMN2) which is available and thus, the UE (100) does not send the leaving coverage notification. Currently, there is no method defined for the UE (100) to correctly determine the leaving coverage indication.

In general, an application function (AF) would benefit from information related to an in-coverage time for the UE (100) using the satellite access and how long the UE (100) may be reachable or available to transfer data during a period of coverage. The AF being aware of the information can be useful so that the AF can modify its behaviour and expectations of communication with the UE (100). If the UE (100) is using discontinuous coverage then and when the UE (100) becomes reachable, a service capability exposure function (SCEF)/network exposure function (NEF) sends a UE monitoring event indicating that the UE (100) has become reachable for the paging. The AF can then use an event to trigger downlink (DL) services or operations on the UE (100). The UE monitoring event for reachability is extended to include a time for which the UE (100) is expected to be in coverage (i.e., expected in coverage time) and can be used assist the AF to understand reachability of the UE (100).

Further, a DCNoserviceapplicability parameter is configured by a serving PLMN/a home public land mobile network (HPLMN) into the UE (100). The DCNoserviceapplicability parameter indicates the UE (100) whether to remain in no service or look for another access/RAT/PLMN for services to the UE (100).

When the DCNoserviceapplicability parameter is set to true, the UE (100) remains in no service during the discontinuous coverage duration and waits for completion of discontinuous coverage to resume a normal service. When the DCNoserviceapplicability parameter is set to false, the UE (100) performs a PLMN selection procedure as described in technical specification (TS) 23.122 to receive the normal services from alternate RAT or different PLMN.

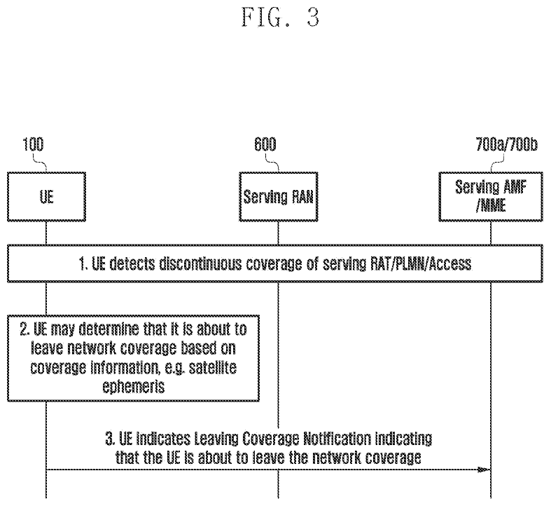

FIG. 3 illustrates a method for determining the leaving coverage indication due to discontinuous coverage or any other unavoidable event according to embodiments as disclosed herein. At step 1, the UE (100) detects the discontinuous coverage of the serving RAT/the PLMN/the access. At step 2, the UE (100) determines that the UE (100) is about to leave the network coverage based on the coverage information. At step 3, the UE (100) indicates the leaving coverage notification indicating that the UE (100) is about to leave the network coverage.

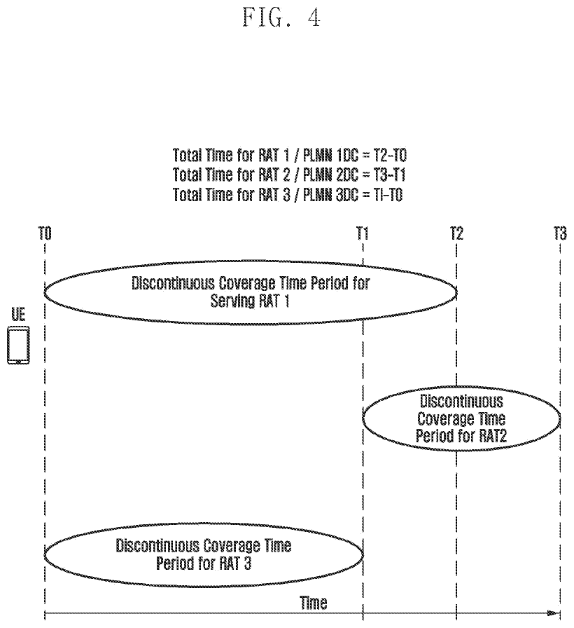

FIG. 4 illustrates an example scenario of determination of expected in-coverage time by the network during the discontinuous coverage or under avoidable situations according to embodiments as disclosed herein.

The network (e.g., AMF apparatus (700a)/policy control function (PCF)/unified data management (UDM)/network exposure function (NEF) or any other network functions) or network functions (like SCEF or NEF) (800) triggers certain events (for e.g., UE monitoring events) towards the application function (AF) (900) indicating that the UE (100) has become reachable for paging and also including the time for which the UE (100) is expected to be in the coverage (expected in coverage time) or expected to be out of coverage. The expected in-coverage time is determined by the network assuming that the UE (100) is allowed to camp/select only on the current RAT/access/PLMN. The UE (100) is in the discontinuous coverage when there is discontinuous coverage of the current RAT/access/PLMN.

In an example, the network determines expected in-coverage time as (T3-T2) as current serving RAT/access/PLMN is not available/is having discontinuous coverage for the UE (100) for time (T2-T0). The network determines this based on the UE indication. There are other satellite RAT(s)/PLMN(s) (e.g., RAT 2/PLMN 2 and RAT 3/PLMN 3) which are available to the UE (100) for the services (at T0 and T1 time respectively).

However, at time T0, the UE (100) selects the service from another RAT or PLMN such RAT2/PLMN2 which is available and provides the service to the UE (100). The UE (100) selects and/or camps on RAT2/PLMN2 and obtains the service. Similarly, at time T1 or at similar times, the UE (100) obtains the service from another RAT or PLMN such as RAT3/PLMN3 which is available and can provide service to the UE (100). The UE (100) selects and/or camps on RAT3/PLMN3 and obtains the service.

In this case, the network is determining and indicating the expected in-coverage time/unreachability time on the basis of the coverage information of the serving RAT/PLMN/access only. But there is/are another RAT/PLMN/access (i.e., RAT 2/PLMN2 or RAT3/PLMN3) which is/are available and thus, the determined expected in-coverage time may not be correct. The in-coverage time is indicating to the AF (900). The AF (900) may wrongly determine that the UE (100) is not available after in-coverage time thus the AF may not send data to the UE (100) whereas the UE (100) may have selected the alternate RAT/PLMN.

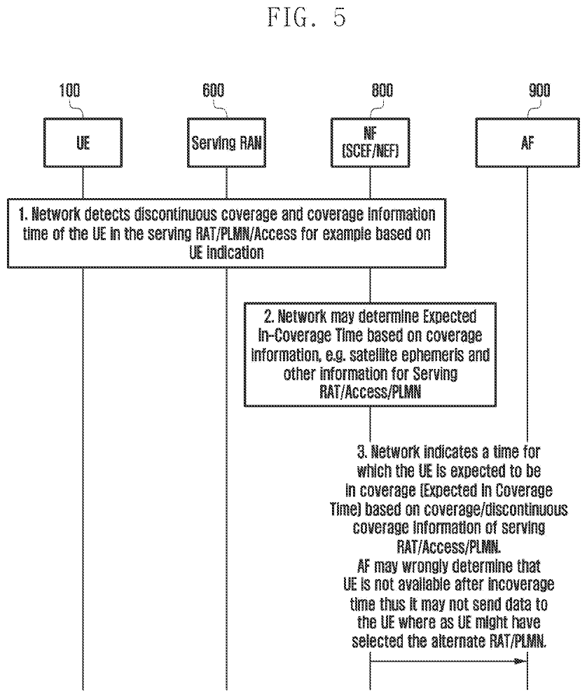

FIG. 5 illustrates a sequence diagram of determination of the expected in-coverage time by the network during the discontinuous coverage or under avoidable situations according to embodiments as disclosed herein. At step 1, the network detects the discontinuous coverage and the coverage information time of the UE (100) in the serving RAT/PLMN/access based on the UE indication. At step 2, the network may determine the expected in-coverage time based on the coverage information, e.g., satellite ephemeris and other information for the serving RAT/access/PLMN. At step 3, the network indicates the time for which the UE (100) is expected to be in the coverage based on coverage/discontinuous coverage information of the serving RAT/access/PLMN. The AF (900) may wrongly determine that the UE (100) is not available after the in a coverage time. Thus, the AF (900) may not send data to the UE (100) whereas the UE (100) may have selected the alternate RAT/PLMN.

It is desired to address the above-mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for determining in-coverage or unreachability information in a satellite area network. The method includes determining, by a UE, that the UE enters a discontinuous coverage on at least one of a PLMN and a RAT in a geographic area. Further, the method includes determining, by the UE, an unreachability period of the UE based on coverage information of at least one of the PLMN and RAT in the geographic area. Further, the method includes determining, by the UE, whether the UE remains in no service on the at least one of the same PLMN and RAT till the coverage returns or the UE selects other PLMN or the RAT to continue to receive the service. In an embodiment, the method includes sending the unreachability period to an AMF apparatus in the satellite area network and performing power saving during the discontinuous coverage when the UE determines to remains in no service on the same PLMN and the RAT till the coverage returns. In another embodiment, the method includes selecting other PLMN or RAT in the geographic area and continuing receiving the service on the other selected PLMN or the RAT in the geographic area when the UE determines to selects the other PLMN or the RAT.

Below are the definition used in the patent disclosure:

Continuous coverage: in non terrestrial networks (NTN), continuous satellite coverage can be characterized by the fact that Uu interface is available for the UE, at a given position for 100% of the time. The Uu is a radio interface between the UE and a Node B/eNB/gNB.

Discontinuous coverage (DC): In the NTN, discontinuous satellite coverage can be characterized by the fact that Uu interface is available for the UE, at a given position, less than 100% of the time, due to predictable lack of satellite coverage.

Satellite ephemeris Information: global positioning system (GPS) satellites transmit information about their location (current and predicted), timing and “health” via what is known as ephemeris data. The ephemeris data is used by the GPS receivers to estimate location relative to the satellites and thus position on earth. The ephemeris data can also be used to predict future satellite conditions (for a given place and time) providing a tool for planning when (or when not) to schedule GPS data collection.

The terms “satellite,” “third generation partnership project (3GPP) access,” “satellite access,” and “NR satellite access” have been interchangeably used and have the same meaning.

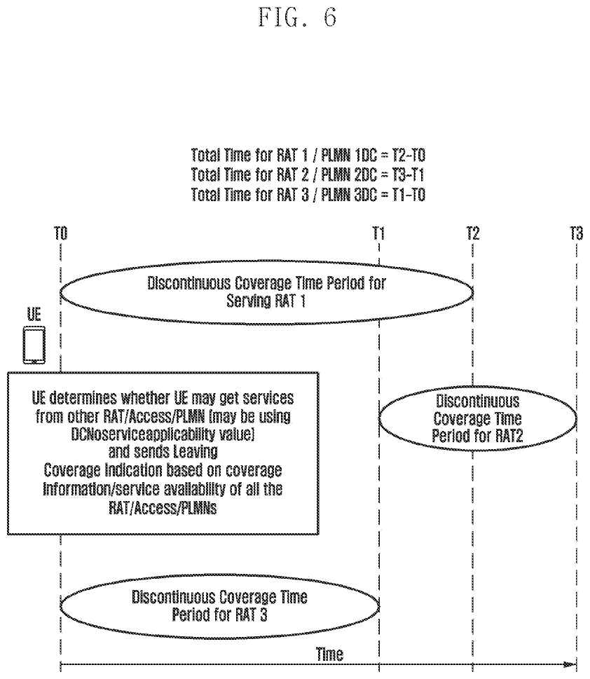

Referring now to the drawings and more particularly to FIGS. 6 through 13, where similar reference characters denote corresponding features consistently throughout the figures, there are shown preferred embodiments.

FIG. 6 illustrates an example scenario of determination of leaving coverage indication due to discontinuous coverage or any other unavoidable event according to embodiments as disclosed herein.

When the UE (100) is in a coverage area of a satellite RAT 1/PLMN 1 and camped, the UE determines that the UE (100) is about to leave the network coverage based on coverage information, e.g., satellite ephemeris, of satellite RAT1/PLMN 1. When, the UE (100) determines that the UE (100) waits for completion of discontinuous coverage to resume normal services, and the UE (100) remains in NO service for example by disabling the access stratum during discontinuous coverage by not searching or selecting for another RAT/access/PLMN over 3GPP access, the UE (100) indicates the leaving coverage indication to the AMF apparatus (700a)/MME apparatus (700b) in the service request/attach procedure/registration procedure/TAU procedure or any other NAS message. The leaving coverage indication includes the unreachability duration determined by the UE (100).

Optionally, the unreachability duration also considers all the available PLMNs or RATs in the area. For example, the UE (100) may be camped on a PLMN-1/RAT-1 e.g., satellite access then the UE may determine, based on ephemeris that is data from PLMN-1, that the UE (100) may not be in coverage for 6 hours, but the UE (100) knows that the PLMN-1/RAT-2 or PLMN-2/RAT-1 is available after 2 hours thus the UE (100) can indicate no service duration for 2 hours because the UE (100) can continue to get the service after 2 hours from other sources of PLMN or RAT. Thus in general UE determines the unreachability duration considering all this aspects.

The UE (100) or the network determines that the UE (100) waits for completion of discontinuous coverage i.e., the UE (100) or the network remains in the NO service in at least one of the below procedures. The below procedures may be considered as examples there can be other procedures in which the UE (100) determines that the UE (100) may remain in the NO service during the discontinuous coverage as shown below examples.
a) In one example, the UE (100) determines whether the UE (100) is not capable (for example the UE supports only satellite access or only a particular RAT) or does not require to select another RAT or PLMN to receive the services. In other words, the UE (100) prioritizes a power saving and remain in the no service or does not attempt to acquire to receive the services.
b) In another example, the UE (100) determines whether to remain in the no service or look for another access/RAT/PLMN for the services to the UE (100) based on DCNoserviceapplicability Parameter which is configured/pre-configured by a serving PLMN/HPLMN into the UE (100) or based on any other information configured or indicated by a HPLMN or a serving network (i.e., serving RAN (600)).
c) In yet another example, when a DCNoserviceapplicability is set to true, the UE (100) remains in the no service during the discontinuous coverage duration and waits for completion of discontinuous coverage to resume a normal service.
d) In yet another example, when the DCNoserviceapplicability is set to false, the UE (100) performs the PLMN selection procedure as described in TS 23.122 to receive the normal services from alternate RAT or different PLMN.

When the UE (100) determines (may be using DCNoserviceapplicability set to FALSE), the UE (100) searches for another RAT/access/PLMN to receive the services. Further, the UE (100) does not indicate the leaving coverage indication or indicates that the UE (100) continues to receive the services when the UE (100) enters the discontinuous coverage by alternate sources like alternate PLMN/RAT to the AMF apparatus (700a)/MME apparatus (700b) in the service request/attach procedure/registration procedure/TAU procedure or any other NAS message when the UE (100) is able to get the service from another RAT/access/PLMN or the UE (100) is still searching for another RAT/access/PLMN. The UE (100) indicates the leaving coverage indication and/or the unreachability duration to the AMF apparatus (700a)/MME apparatus (700b) in the service request/attach procedure/registration procedure/TAU procedure based on the coverage or discontinuous coverage information of all the possible or supported RAT/access/PLMN.

In another embodiment, when the UE (100) indicates the leaving coverage indication and/or the unreachability duration to the AMF apparatus (700a)/the MME apparatus (700b) in the service request/attach procedure/registration procedure/TAU procedure or any other NAS message, the network may not consider the UE (100) as unreachable if the network (e.g., AMF apparatus (700a)/MME apparatus (700b)) determines (may be using DCNoserviceapplicability set to FALSE) that the UE (100) triggers PLMN search/PLMN selection on other RAT/access/PLMNs. The network indicates back to the UE (100) in the NAS message that its unreachability indication is not accepted by the network.

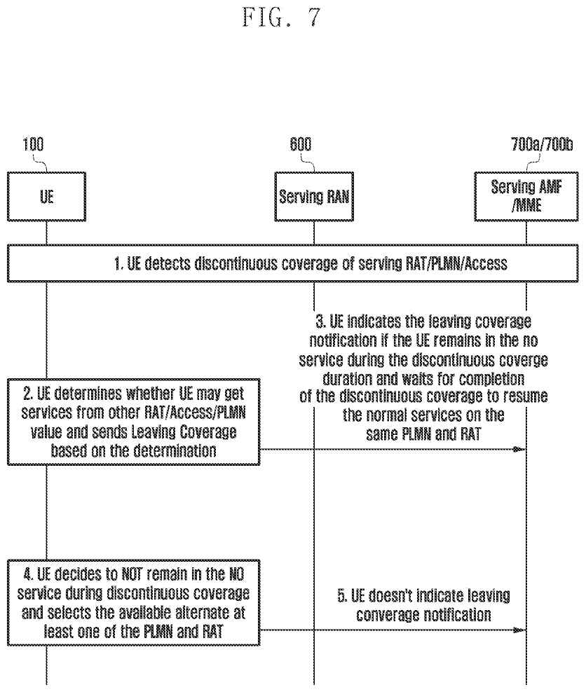

FIG. 7 illustrates a sequence diagram illustrating determination of leaving coverage indication due to the discontinuous coverage or any other unavoidable event according to embodiments as disclosed herein.

At step 1, the UE (100) detects the discontinuous coverage of the serving RAT/PLMN/access. At step 2, the UE (100) determines whether the UE (100) gets the services from other RAT/access/PLMN value and sends the leaving coverage based on the detection. At step 3, the UE (100) indicates the leaving coverage notification if the UE (100) remains in the no service during the discontinuous coverage duration and waits for completion of the discontinuous coverage to resume the normal services on the same PLMN and RAT. At step 4, the UE (100) decides to NOT remain in the NO service during discontinuous coverage and select available alternate at least one of the PLMN and RAT. At step 5, the UE (100) does not indicate the leaving coverage notification.

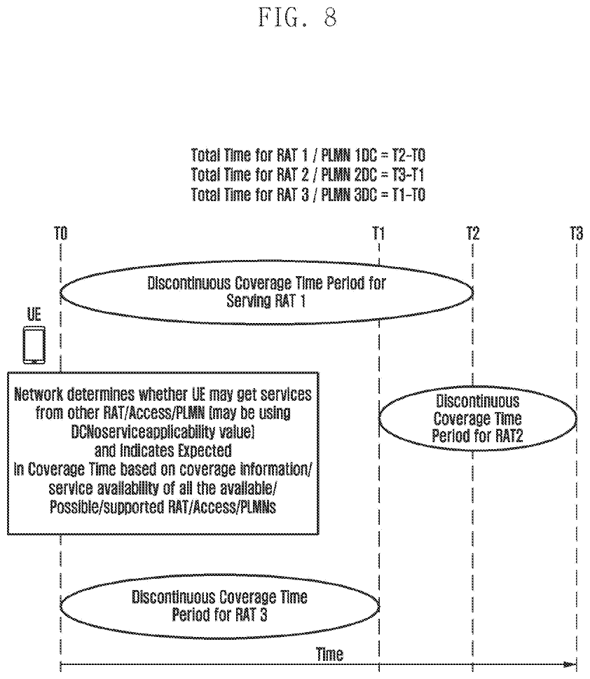

FIG. 8 illustrating a scenario of determination of expected in-coverage time by the network during the discontinuous coverage or under avoidable situations according to embodiments as disclosed herein.

The network determines whether the UE (100) remains in the no service or looks for another access/RAT/PLMN for services for e.g., using the DCNoserviceapplicability parameter which is configured/pre-configured by serving PLMN/HPLMN into the UE (100). In an example, when the DCNoserviceapplicability is set to true, the UE (100) remains in the no service during the discontinuous coverage duration and waits for completion of the discontinuous coverage to resume the normal services. If DCNoserviceapplicability is set to false then the UE (100) performs the PLMN selection procedure as described in TS 23.122 to receive the normal services from alternate RAT or different PLMN.

If the network or the UE (100) determines (may be using DCNoserviceapplicability set to TRUE or based on the UE indication) that the UE (100) waits for completion of discontinuous coverage to resume the normal services. Further, the UE (100) does not search for another RAT/access/PLMN and the UE (100) remains no service for example the UE disables the access stratum, in that case, the network indicates the expected in coverage time/unreachability duration to the AF (900) based on the coverage of the current serving RAT/access/PLMN. If the network or the UE (100) determines (may be using DCNoserviceapplicability set to FALSE) that the UE (100) searches for another RAT/access/PLMN and receives the normal services by registering with them, then the network indicates the expected in coverage time/or the unreachability duration to the AF (900) based on the coverage/service availability to the UE (100) from all the available/possible/supported RAT/access/PLMN or as indicated by the UE (100) or NF like the AMF apparatus (700a). The network does not indicate the in-coverage information/out of coverage information to the AF (900) through the NEF. The NF like AMF apparatus (700a) can indicate to the AF (900) through NEF if the NF like AMF is subscribed for such events for e.g., monitoring events.

When the network or network functions (like SCEF or NEF or the like) (800) triggers the certain events (for e.g., UE monitoring events) towards the AF (900) indicating that the UE (100) has become reachable for paging and also including the time for which the UE (100) is expected to be in coverage (i.e., expected in coverage time).

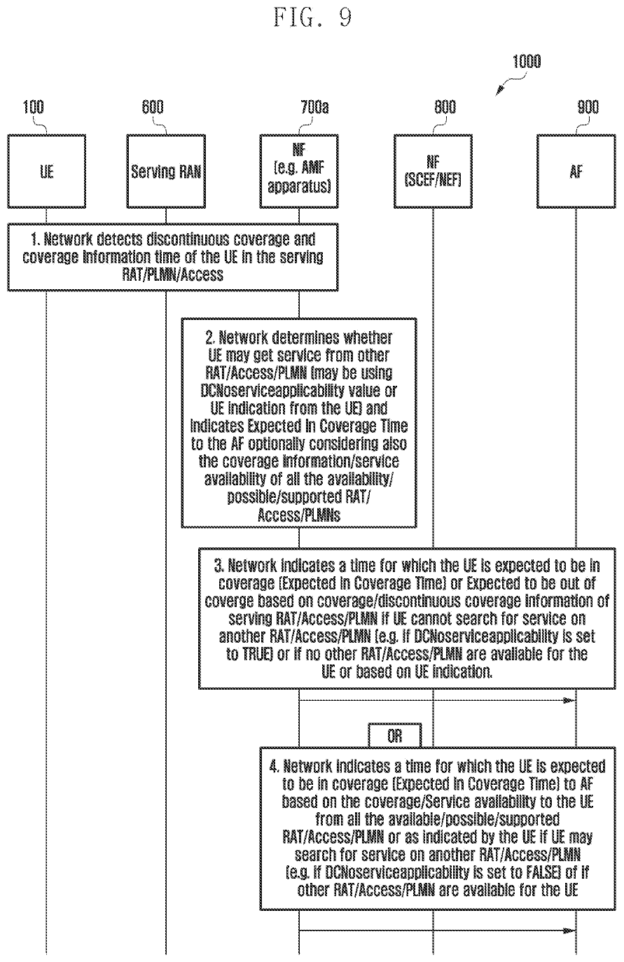

FIG. 9 illustrates a sequence diagram of a scenario of determination of expected in-coverage time by the network during discontinuous coverage or under avoidable situations according to embodiments as disclosed herein.

At step 1, the network detects the discontinuous coverage and coverage information time of the UE (100) in the serving RAT/PLMN/access. At step 2, the network determines whether the UE (100) may get services from other RAT/access/PLMN (for example by using DCNoserviceapplicability value or UE indication from the UE (100)) and indicates expected in coverage time to the AF (900). Optionally, the UE (100) may indicate the coverage information/service availability of all the available/possible/supported RAT/access/PLMNs to the AF (900).

At step 3, the network indicates the time for which the UE (100) is expected to be in coverage or expected to be out of coverage based on coverage/discontinuous coverage information of the serving RAT/access/PLMN if the UE (100) cannot search for service on another RAT/access/PLMN (e.g., if DCNoserviceapplicability is set to TRUE) or if no other RAT/access/PLMN are available for the UE (100) or based on UE indication.

At step 4, the network indicates the time for which the UE (100) is expected to be in coverage to the AF (900) based on the coverage/Service availability to the UE (100) from all the available/possible/supported RAT/access/PLMN or as indicated by the UE (100) when the UE (100) may search for service on another RAT/access/PLMN or when other RAT/access/PLMN are available for the UE (100).

In an embodiment, when the UE (100) or the network determines that the UE (100) is going to be unavailable due to any unavoidable event or discontinuous coverage, the UE (100) looks in a UE location area for all other available RATs (e.g., terrestrial network (TN) or non-terrestrial network (NTN)) before indicating the leaving notification indication or the unreachability duration. When the UE (100) does not get or the UE (100) determines that the UE (100) does not get the service, the UE (100) indicates the determined information(e.g., unavailability duration) to the network so that the network can determine the reachability of the UE (100) and indicate the same to the AF (900).

When the network or the network functions (like SCEF or NEF) (800) triggers the certain events (for e.g., UE monitoring events) towards the AF (900) indicating that the UE (100) has become reachable for paging and also includes the time for which the UE (100) is expected to be in coverage. In an embodiment, wherever the expected in coverage time is indicated or is specified at the same place, the network determines whether the UE (100) gets the services from other RAT/access/PLMN (may be using DCNoserviceapplicability value) and indicates to the AF (900) or an application server.

The provided method can be extended for a MICO and Non-MICO mode UE(s) where the network or the UE (100) determines the correct active timer based on whether the UE (100) obtains the services from other RAT/access/PLMN (may be using DCNoserviceapplicability value). The network keeps the UE (100) in the CONNECTED mode for a longer or a shorter duration based on coverage information/service availability of all the available/possible/supported RAT/access/PLMNs and the UE capability to trigger a search for another RAT/access/PLMN during discontinuous coverage of serving RAT/access/PLMN (may be using DCNoserviceapplicability value).

In an embodiment, the provided method is also applicable to other network function (NF) such as PCF/UDM/NEF.

The network determination can also be based on the methods described for UE determination or vice versa to determine if the UE (100) remains in no service or the UE (100) may acquire the service on other (alternate) PLMN/RAT to continue to receive service.

In an embodiment, the terms RAT and access are used interchangeably. In another embodiment, the terms Registration Procedures and registration is used interchangeably.

Yet in another embodiment, if there are other RATs available when the UE (100) is going in the discontinuous coverage on the serving RAT/PLMN and the UE (100) is allowed to get the services from other RATs, and the UE (100) can get services from some of the RATs before the discontinuous coverage ends for the current serving RAT/PLMN, then it may be up to UE implementation that how the UE (100) or the network determines the leaving notification indication, expected in coverage time, unreachability period (time or duration or indicate start time/end time etc), active time/timer, connected mode time and other such timers/parameters.

In an embodiment, the radio access technology (RAT) is at least one of a new radio (NR), a NR in unlicensed bands, a NR low earth orbit (LEO) satellite access, a NR medium earth orbit (MEO) satellite access, a NR geostationary orbit (GEO) satellite access, a NR (OTHERSAT) satellite access, a NR RedCap, an evolved universal mobile telecommunication access (E-UTRA), an E-UTRA in unlicensed bands, an NB-Internet of Things (IoT), and a long term evolution machine type communication (LTE-M).

In an embodiment, when the UE (100) enters the NO service or limited, the UE (100) may enter at least one of the 5GMM sublayer states in 5GS e.g., 5GMM-REGISTERED.NO-CELL-AVAILABLE or EMM sublayer states e.g., EMM-REGISTERED.NO-CELL-AVAILABLE in EPS (or 4G system).

The term 5GMM sublayer states in this embodiment are at least one of the below:
1) 5GMM-NULL,
2) 5GMM-DEREGISTERED,
   a) 5GMM-DEREGISTERED.NORMAL-SERVICE,
   b) 5GMM-DEREGISTERED.LIMITED-SERVICE,
   c) 5GMM-DEREGISTERED.ATTEMPTING-REGISTRATION,
   d) 5GMM-DEREGISTERED.PLMN-SEARCH,
   e) 5GMM-DEREGISTERED.NO-SUPI,
   f) 5GMM-DEREGISTERED.NO-CELL-AVAILABLE,
   g) 5GMM-DEREGISTERED.eCALL-INACTIVE,
   h) 5GMM-DEREGISTERED.INITIAL-REGISTRATION-NEEDED,
3) 5GMM-REGISTERED-INITIATED,
4) 5GMM-REGISTERED,
   a) 5GMM-REGISTERED.NORMAL-SERVICE,
   b) 5GMM-REGISTERED.NON-ALLOWED-SERVICE,
   c) 5GMM-REGISTERED.ATTEMPTING-REGISTRATION-UPDATE,
   d) 5GMM-REGISTERED.LIMITED-SERVICE,
   e) 5GMM-REGISTERED.PLMN-SEARCH,
   f) 5GMM-REGISTERED.NO-CELL-AVAILABLE,
   g) 5GMM-REGISTERED.UPDATE-NEEDED,
5) 5GMM-DEREGISTERED-INITIATED, and
6) 5GMM-SERVICE-REQUEST-INITIATED.

In embodiments herein, the term EMM sublayer states are at least one of the below:
1) EMM-NULL,
2) EMM-DEREGISTERED,
   a) EMM-DEREGISTERED.NORMAL-SERVICE,
   b) EMM-DEREGISTERED.LIMITED-SERVICE,
   c) EMM-DEREGISTERED.ATTEMPTING-TO-ATTACH,
   d) EMM-DEREGISTERED.PLMN-SEARCH,
   e) EMM-DEREGISTERED.NO-IMSI,
   f) EMM-DEREGISTERED.ATTACH-NEEDED,
   g) EMM-DEREGISTERED.NO-CELL-AVAILABLE,
   h) EMM-DEREGISTERED.eCALL-INACTIVE,
3) EMM-REGISTERED-INITIATED,
4) EMM-REGISTERED,
   a) EMM-REGISTERED.NORMAL-SERVICE,
   b) EMM-REGISTERED.ATTEMPTING-TO-UPDATE,
   c) EMM-REGISTERED.LIMITED-SERVICE,
   d) EMM-REGISTERED.PLMN-SEARCH,
   e) EMM-REGISTERED.UPDATE-NEEDED,
   f) EMM-REGISTERED.NO-CELL-AVAILABLE,
   g) EMM-REGISTERED.ATTEMPTING-TO-UPDATE-MM,
   h) EMM-REGISTERED.IMSI-DETACH-INITIATED,
5) EMM-DEREGISTERED-INITIATED,
6) EMM-TRACKING-AREA-UPDATING-INITIATED, and
7) EMM-SERVICE-REQUEST-INITIATED.

The term RAT as defined in this embodiment can be one of the following:-
a) NG-RAN,
b) 5G, 4G, 3G, 2G,
c) EPS, 5GS,
d) NR,
e) NR in unlicensed bands,
f) NR (LEO) satellite access,
NR (MEO) satellite access,
g) NR (GEO) satellite access,
h) NR (OTHERSAT) satellite access,
i) NR RedCap,
j) E-UTRA,
k) E-UTRA in unlicensed bands,
l) NB-IoT,
m) WB-IoT, and
n) LTE-M.

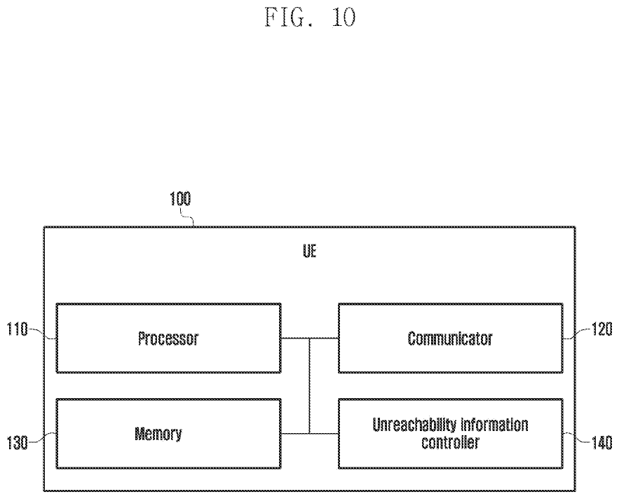

FIG. 10 illustrates hardware components of the UE (100), according to the embodiments as disclosed herein. In an embodiment, the UE (100) includes a processor (110), a communicator (120), a memory (130) and an unreachability information controller (140). The processor (110) is coupled with the communicator (120), the memory (130) and the unreachability information controller (140). The communicator (120) is also defined as a transceiver. The processor (110) is also defined a controller and the unreachability information controller (140) can be included in the processor (110).

The unreachability information controller (140) determines that the UE (100) enters discontinuous coverage on the PLMN and the RAT in the geographic area. Further, the unreachability information controller (140) determines the unreachability period of the UE (100) based on the coverage information of the PLMN and the RAT in the geographic area. Further, the unreachability information controller (140) determines whether the UE (100) remains in no service on the at least one of the same PLMN and RAT till the coverage returns or the UE (100) selects other PLMN or the RAT to continue to receive the service.

In an embodiment, the unreachability information controller (140) sends the unreachability period (also called as unavailability duration) to the AMF apparatus (700a) in the satellite area network (1000) and performs power saving during the discontinuous coverage when the UE (100) determines to remains in no service on the same PLMN and the RAT till the coverage returns. The procedure to perform power saving is at least one of the deactivating an access stratum during the discontinuous coverage. The access stratum is deactivated during the discontinuous coverage by considering all or at least one for the RATs supported by the UE (100) in order to optimise power consumption until the coverage returns.

In another embodiment, the unreachability information controller (140) selects other PLMN or RAT in the geographic area and continue receives the service on the other selected PLMN or the RAT in the geographic area when the UE (100) determines to selects the other PLMN or the RAT.

Further, the unreachability information controller (140) triggers the mobility registration update procedure with sufficient time to complete the procedure before start of the unreachability period for at least one of when the UE (100) determines to remains in no service on the same PLMN and the RAT till the coverage returns:
a) request MICO mode parameters, extended DRX in connection management-IDLE (CM-IDLE) parameters, or other NAS timers taking the unreachability period of the UE (100) into account;
b) inform the AMF apparatus (700a) of the unreachability period, when the UE (100) is about to leave the coverage of the PLMN; and
c) inform the AMF apparatus (700a) about the UE (100) is entering discontinuous coverage.

The unreachability information controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in random access memory (RAM) or cache).

Although the FIG. 10 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

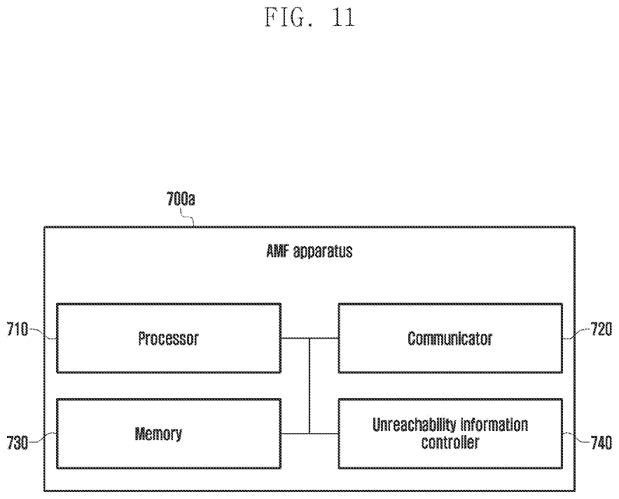

FIG. 11 illustrates various hardware components of the AMF apparatus (700a) according to the embodiments as disclosed herein. In an embodiment, the AMF apparatus (700a) includes a processor (710), a communicator (720), a memory (730) and an unreachability information controller (740). The processor (710) is coupled with the communicator (720), the memory (730) and the unreachability information controller (740).

The unreachability information controller (740) receives the unreachability period of the UE (100) in the geographic area. Further, the unreachability information controller (740) marks unreachability of the UE (100) in the geographic area based on the received unreachability period of the UE (100). i.e., when the UE (100) is not reachable, the network may not page the UE (100).

The unreachability information controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. The term “non-transitory” should not be interpreted that the memory (730) is non-movable. In certain examples, a non-transitory storage medium may store data that can, over time, change (e.g., in random access memory (RAM) or cache).

Although the FIG. 11 shows various hardware components of the AMF apparatus (700a) but it is to be understood that other embodiments are not limited thereon. In other embodiments, the AMF apparatus (700a) may include less or more number of components. Further, the labels or names of the components are used only for illustrative purpose and does not limit the scope of the disclosure. One or more components can be combined together to perform same or substantially similar function in the AMF apparatus (700a).

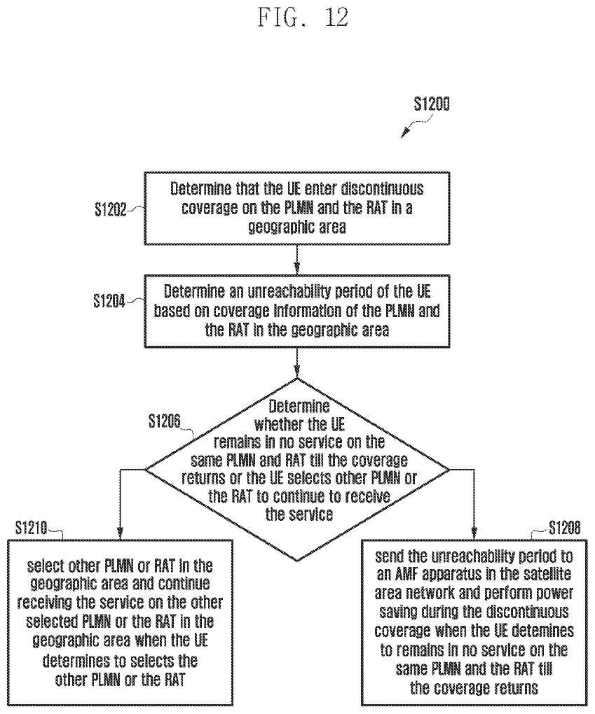

FIG. 12 illustrates a flowchart (S1200) of a method, implemented by the UE (100), for determining the in-coverage or the unreachability information in the satellite area network (1000) according to the embodiments as disclosed herein. The operations (S1202-S1210) are handled by the unreachability information controller (140).

At S1202, the method includes determine that the UE (100) enters the discontinuous coverage on the PLMN and the RAT in the geographic area. At S1204, the method includes determining the unreachability period of the UE (100) based on the coverage information of the PLMN and the RAT in the geographic area. At S1206, the method includes determining whether the UE (100) remains in no service on the same PLMN or the RAT till the coverage returns or the UE (100) selects other PLMN or the RAT to continue to receive the service.

At S1208, the method includes sending the unreachability period to the AMF apparatus (700a) in the satellite area network (1000) and performing power saving during the discontinuous coverage when the UE (100) determines to remains in no service on the same PLMN and the RAT till the coverage returns. At S1210, the method includes selecting other PLMN or RAT in the geographic area and continue receiving the service on the other selected PLMN or the RAT in the geographic area when the UE (100) determines to selects the other PLMN or the RAT.

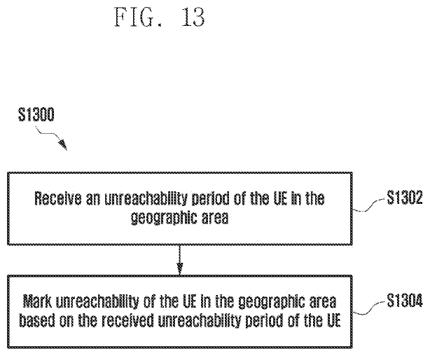

FIG. 13 illustrates a flowchart (S1300) of a method, implemented by the AMF apparatus (700a), for determining the in-coverage or the unreachability information in the satellite area network (1000) according to embodiments as disclosed herein. The operations (S1302 and S1304) are handled by the unreachability information controller (740).

At S1302, the method includes receiving the unreachability period of the UE (100) in the geographic area. At S1304, the method includes marking the unreachability of the UE (100) in the geographic area based on the received unreachability period of the UE (100).

The various actions, acts, blocks, steps, or the like in the flow charts (S1200 and S1300) may be performed in the order presented, in a different order or simultaneously. Further, in some embodiments, some of the actions, acts, blocks, steps, or the like may be omitted, added, modified, skipped, or the like without departing from the scope of the disclosure.

The terms “satellite 3GPP access,” “satellite access,” “satellite access network,” “NR satellite access network,” “satellite NG-RAN access technology,” and “NR satellite access” have been interchangeably used and have the same meaning in the patent disclosure.

The methods, issues or solutions disclosed in this embodiment are explained using NR satellite access or satellite NG-RAN access technology as an example and is not restricted or limited to NR satellite access only. However, the solutions provided in this embodiment are also applicable for satellite evolved UMTS terrestrial radio access network (E-UTRAN) access technology, narrow band (NB)-S1 mode or wide band (WB)-S1 mode via satellite E-UTRAN access and/or NB-IOT (narrow band Internet Of Things) or WB-IOT (wide band Internet Of Things) satellite access/architecture.

The solutions which are defined for NR(5GC) are also applicable to legacy RATs like E-UTRA/long term evolution (LTE), the corresponding core network (CN) entities needs to be replaced by LTE entities for e.g., AMF with MME, g-nodeB with e-nodeB, UDM with home subscriber server (HSS) etc. But principles of the solution remains same.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

In an embodiment, performing power saving is at least one of the deactivating an access stratum (AS) during the discontinuous coverage.

In an embodiment, the access stratum is deactivated during the discontinuous coverage by considering all RATs supported by the UE in order to optimise power consumption until the coverage returns.

In an embodiment, the method includes triggering, by the UE, a mobility registration update procedure with sufficient time to complete the procedure before start of the unreachability period for at least one of:
a) request mobile initiated communication only (MICO) mode parameters, extended discontinuous reception (extended DRX) in CM-IDLE parameters, or other NAS timers taking the unreachability period of the UE into account;
b) inform the AMF apparatus of the unreachability period, when the UE is about to leave the coverage of the PLMN; and
c) inform the AMF apparatus about UE is entering discontinuous coverage.

Accordingly, the embodiment herein is to provide a method for determining in-coverage or unreachability information in a satellite area network. The method includes receiving, by an AMF apparatus, an unreachability period of the UE in the geographic area. Further, the method includes marking, by the AMF apparatus, unreachability of the UE in the geographic area based on the received unreachability period of the UE.

Accordingly, the embodiment herein is to provide a UE for determining in-coverage or unreachability information in a satellite area network. The UE includes an unreachability information controller communicatively coupled to a memory and a processor. The unreachability information controller is configured to determine that the UE enter discontinuous coverage on at least one of a PLMN and a RAT in a geographic area. Further, the unreachability information controller is configured to determine an unreachability period of the UE based on coverage information of at least one of the PLMN and the RAT in the geographic area. Further, the unreachability information controller is configured to determine whether the UE remains in no service on the at least one of the same PLMN and RAT till the coverage returns or the UE selects other PLMN or the RAT to continue to receive the service.

In an embodiment, the unreachability information controller is configured to send the unreachability period to an AMF apparatus in the satellite area network and perform power saving during the discontinuous coverage when the UE determines to remains in no service on the same PLMN and the RAT till the coverage returns. In another embodiment, the unreachability information controller is configured to select other PLMN or RAT in the geographic area and continue receiving the service on the other selected PLMN or the RAT in the geographic area when the UE determines to selects the other PLMN or the RAT.

Accordingly, the embodiment herein is to provide an AMF apparatus for determining in-coverage or unreachability information in a satellite area network. The AMF apparatus includes an unreachability information controller communicatively coupled to a memory and a processor. The unreachability information controller is configured to receive an unreachability period of the UE in the geographic area. Further, the unreachability information controller is configured to mark unreachability of the UE in the geographic area based on the received unreachability period of the UE.

These and other aspects of the embodiments herein will be better appreciated and understood when considered in conjunction with the following description and the accompanying drawings. It should be understood that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) in a satellite area network, the method comprising:
determining that the UE to be in a discontinuous coverage on a radio access technology (RAT);
determining an unreachability period of the UE based on coverage information of the RAT;
determining whether the UE remains in no service on the RAT by considering another RAT until a coverage returns; and
transmitting, to an access and mobility management function (AMF), the unreachability period in case that the UE remains in no service on the RAT.

2. The method of claim 1, further comprising:
selecting another RAT in case that the UE does not remain in no service on the RAT; and
performing a communication with the selected other RAT.

3. The method of claim 1, further comprising:
deactivating an access stratum of the UE to optimize power consumption until the coverage returns in case that the UE remains in no service on the RAT.

4. The method of claim 3, wherein the access stratum of the UE is deactivated during the discontinuous coverage by considering all RATs supported by the UE in order to optimise power consumption until the coverage returns.

5. The method of claim 1, wherein a mobility registration update procedure is triggered, before start of the unreachability period, to at least one of:
request mobile initiated communication only (MICO) mode parameters, extended discontinuous reception (eDRX) in connection management-IDLE (CM-IDLE) parameters, or other non-access stratum (NAS) timers taking the unreachability period of the UE into account;
inform the AMF of the unreachability period when the UE is about to leave the coverage; or
inform the AMF about the UE is entering the discontinuous coverage.

6. The method of claim 1, further comprising:
determining that the UE to be in a discontinuous coverage on a public land mobile network (PLMN);
determining an unreachability period for the PLMN based on coverage information of the PLMN;
determining whether the UE remains in no service on the PLMN by considering another PLMN until a coverage returns; and
transmitting, to the AMF, the unreachability period for the PLMN in case that the UE remains in no service on the PLMN.

7. A method of an access and mobility management function (AMF) in a satellite area network, the method comprising:
receiving an unreachability period of a user equipment (UE); and
marking unreachability of the UE based on the received unreachability period of the UE.

8. The method of claim 7, further comprising:
transmitting, to an application function, the unreachability period of the UE.

9. A user equipment (UE) in a satellite area network, the UE comprising:
a transceiver; and
at least one processor operably coupled to the transceiver, the at least one processor configured to:
determine that the UE to be in a discontinuous coverage on a radio access technology (RAT),
determine an unreachability period of the UE based on coverage information of the RAT,
determine whether the UE remains in no service on the RAT by considering another RAT until a coverage returns, and
transmit, to an access and mobility management function(AMF), the unreachability period, in case that the UE remains in no service on the RAT.

10. The UE of claim 9, wherein the at least one processor is further configured to:
select another RAT in case that the UE does not remain in no service on the RAT; and
perform a communication with the selected another RAT.

11. The UE of claim 9, wherein the at least one processor is further configured to:
deactivate an access stratum of the UE to optimize power consumption until the coverage returns, in case that the UE remains in no service on the RAT.

12. The UE of claim 11, wherein the access stratum of the UE is deactivated during the discontinuous coverage by considering all RATs supported by the UE in order to optimise power consumption until the coverage returns.

13. The UE of claim 9, wherein the at least one processor is further configured to trigger a mobility registration update procedure before start of the unreachability period for at least one of:
request mobile initiated communication only (MICO) mode parameters, extended discontinuous reception (eDRX) in connection management-IDLE(CM-IDLE) parameters, or other non-access stratum (NAS) timers taking the unreachability period of the UE into account;
inform the AMF of the unreachability period when the UE is about to leave the coverage; or
inform the AMF about the UE is entering the discontinuous coverage.

14. The UE of claim 9, wherein the at least one processor is further configured to:
determine that the UE to be in a discontinuous coverage on a public land mobile network (PLMN),
determine an unreachability period for the PLMN based on coverage information of the PLMN;
determine whether the UE remains in no service on the PLMN by considering another PLMN until a coverage returns; and
transmit, to the AMF, the unreachability period for the PLMN in case that the UE remains in no service on the PLMN.

15. An access and mobility management function (AMF) in a satellite area network, the AMF comprising:
a transceiver; and
at least one processor operably coupled to the transceiver, the at least one processor configured to:
receive an unreachability period of a user equipment (UE); and
mark unreachability of the UE based on the received unreachability period of the UE.
